(19) United States
(12) Patent Application Publication
(10) Pub. No.: US 2005/0280534 A1
(43) Pub. Date: Dec. 22, 2005

(54) Clothing item registration system

(76) Inventor: Pamela Wright Navarro, Miami, FL (US)

Correspondence Address: FLEIT, KAIN, GIBBONS, GUTMAN, BONGINI;& BIANCO P.L., ONE BOCA COMMERCE CENTER, 551 NORTHWEST 77TH STREET, SUITE 111, BOCA RATON, FL, 33487, US

(21) Appl. No.: 10/869,470

(22) Filed: Jun. 16, 2004

(51) Int. Cl. G06F 17/60

(52) U.S. Cl. 340/572.1; 705/28

(57) ABSTRACT

A clothing registration system includes a unique identifier that identifies a clothing item's membership and place within a finite production run. The system further includes a database containing records corresponding to clothing items and searchable to confirm that a clothing item belongs to the finite group and is of a particular position within the group.

### BACKGROUND OF THE INVENTION

1. Field of the Invention

This invention relates in general to clothing and more particularly, to a system for registering clothing items belonging to a limited production run.

2. Description of the Related Art

The clothing one wears is often an important symbol of status. Depending on the designer, an article of clothing can cost anywhere from a few dollars to tens of thousands of dollars. As a result, few can afford to by from the most highly-regarded designers. In many countries, including the United States, the media is a indicator of the public fascination with fashion. Entire television programs are dedicated to what celebrities wear to special events, such as awards shows, parties, and charity events. This is most-likely true because celebrities are among the highest-paid individuals and can afford to wear clothing from designers that most can not afford.

Many designers/manufacturers escalate the value of an item by only producing a finite number of the item. For instance, a manufacturer will produce only five dresses designed by a particular designer, creating a very limited group of individuals owning that dress. Instant status is gained by those lucky enough to obtain one of the only five dresses. In addition, it is not unusual for an individual to pay a large price to have a garment specially designed and made for that individual only. It may be desirable to that person to ensure that the garment is not reproduced by the designer and sold to other individuals. However, currently, a consumer has no method of verifying the claim that a clothing item is of a particular finite group, as claimed by a manufacturer.

Even with clothing items that are manufactured in mass, an entire hierarchy of design sources exists in the marketplace. This hierarchy provides clothing purchasers a broad range of price options. In many cases, the value of a particular piece of clothing is a function solely of its source, while the materials and workmanship play very little, or no part at all, in the price. Along the same line of reasoning, obtaining one of a relatively large production run also brings with it status and value, but on a relative scale.

For this reason, it is important to the designer, manufacture, and retail point of sale, that the item's source be easily identified and that unauthorized reproductions of the clothing items are prevented from entering the marketplace. For example, if a competitor makes exact copies of the dress discussed in the previous paragraph, the value of owning one of the five originals will be diminished. A consumer may not even realize that they are purchasing an unauthorized copy of the item.

Attaching tags and logos, using color schemes, and creating unique styles are common methods to positively identify source. In the United States, as well as many other countries, Trademark laws encourage methods of identifying source and protect against those creating consumer confusion. These laws provide heavy penalties for those trying to trade under the goodwill of another. Regardless, due to the nature of the business, it is difficult for clothing manufacturers to prevent copying of their designs. Even the fear that a genuine article might not be authentic can adversely affect the purchase price of that article.

Accordingly, a need exists for a system for quickly, easily, and reliably verifying the authenticity of a clothing article's source and membership in a limited production run.

### SUMMARY OF THE INVENTION

The present invention concerns a clothing authentication system. The clothing authentication system includes a set of unique identifiers each assigned to an individual article of clothing belonging to a finite group of similar items. The unique identifier can be utilized by a purchaser to verify that the clothing article is from the advertised source and that it is from a particular production group. The identifier may further be used to determine specifically which number within the finite group the particular item is assigned.

In one embodiment, a tag is attached to clothing items. The tag contains a unique identifier number assigned only to the clothing item to which it is attached. The purchaser of the clothing item can then, utilizing the internet, navigate to the manufacturer's website, enter the unique identifier, and receive, if the item is authentic, a response from the website indicating that the item is authentic and which number within a finite group the item is assigned. The purchaser can also enter personal information about the purchaser, such as name, address, phone number, and any other relevant information. The item is then registered to that purchaser. Once authentication is confirmed, no one else may register that identifier.

The unique identifier can be in the form of numbers, letters, characters, graphics, colors, shapes scannable bars, magnetic stripes, a combination thereof, and more, and may be concealed until the purchase is complete to prevent fraudulent registration.

In other embodiments, the purchaser can enter the unique identifier by using a telephone, an in-store computer system, or by mailing a request for authentication to a record keeping entity.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a diagram illustrating a clothing item with an ID tag, as can be found in a common retail sales location;

FIG. 2 is a diagram of a computer network;

FIG. 3 is a diagram of a tag containing a unique identifier in a variety of possible formats;

FIG. 4 is a diagram illustrating one method of concealing a unique identifier;

FIG. 5 is a diagram illustrating a card with a magnetic stripe containing a unique identifier; and

FIG. 6 is a diagram illustrating a mail-in card for registering/confirming an items authenticity.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward.

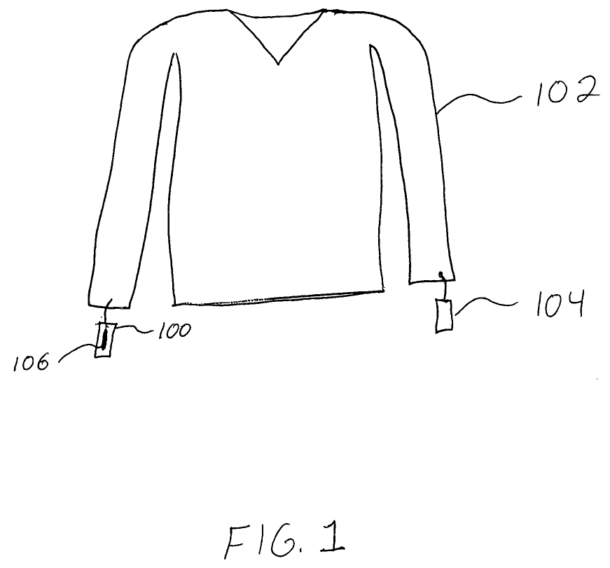

FIG. 1 shows a clothing item 102. The particular item shown is a shirt; however, as will be clear from the following description, the present invention can be used equally as well for any clothing item. Additionally, the present invention can be used for items that are not necessarily clothing items.

The clothing item 102 shown in FIG. 1 is typical of items found in common retail clothing outlets. An inventory tag 104 is attached to item 102. Inventory tags 104 are well known in the art and are provided with codes to facilitate inventory control, numbers to indicate price to consumers, brand names to indicate source, and any of a variety of other purposes.

FIG. 1 also shows a tag 100 attached to item 102. Tag 100 includes a unique identifier 106. The unique identifier 106 is preferably a series of numbers, but, as will be described later, can take the form of several alternative embodiments. The identifier 106 can identify the garment to which it is attached, exclusive of all other garments. In this way, it will be possible to trace the item to determine its source as well as other facts pertaining to the item. For instance, the identifier 106 can be constructed so as to identify a style, factory where made, date of manufacture, material used, total number of identical items manufactured, the item's particular manufacture number within the total manufacturing run, and more.

Although the tag 100 is shown in FIG. 1 as being attached to the item 102, it does not have to be attached in the manner shown and does not necessarily have to be attached at all. In some alternative embodiments, tag 102 can be sewn into the garment, be provided as a sticker adhering to the surface of the garment, be given to the purchaser at the time of sale, or other similar methods.

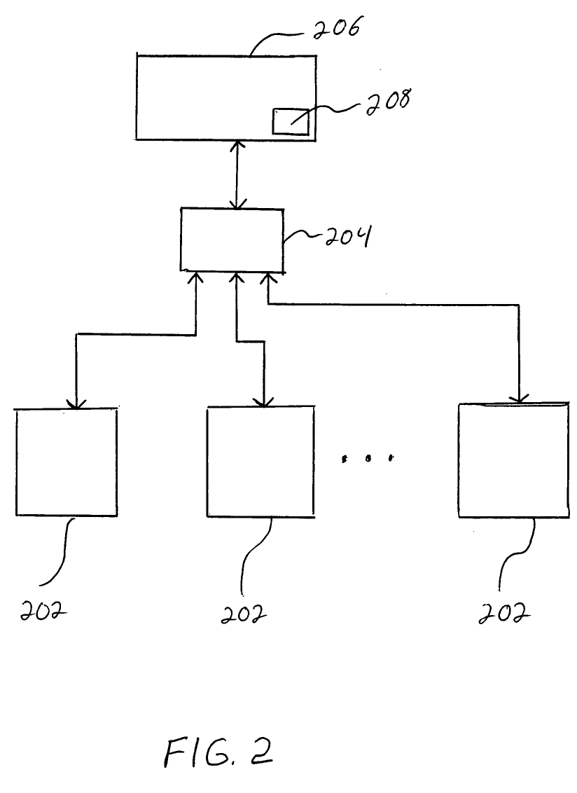

FIG. 2 shows a computer network 200. In FIG. 2, a series of computers 202 are connected through provider equipment 204 to a central processing unit 206, capable of accessing a database 208. Processing unit 206 is accessible to all of the computers 202 on the network 200. The configuration shown in FIG. 2 is representative of the internet, which is well known by those of skill in the art. In one embodiment of the present invention, a purchaser can operate any one of the computers 202 to access, through the provider equipment 204, the database 208, maintained by the clothing manufacturer or some reliable information host. The identifier 106 contained on the tag 100 can be submitted to the processing unit 206, which then searches the database 208 for information pertaining to the unique identifier 106. If information is found, the processor 206 returns a message to the computer 202 indicating as such. In this manner, a purchaser can verify, through the computer network 200 that a particular item conforms to claims made by the seller.

Various methods can be utilized to restrict access to the database 208 to only select individuals, in particular, purchasers. An effective method commonly used today is password protection, where access is granted only after a user successfully submits a series of numbers and/or letters in reply to a request for a password. At the time of purchase, a consumer can be given a password, allowing access to the database 208 only to the consumers of the item being sold.

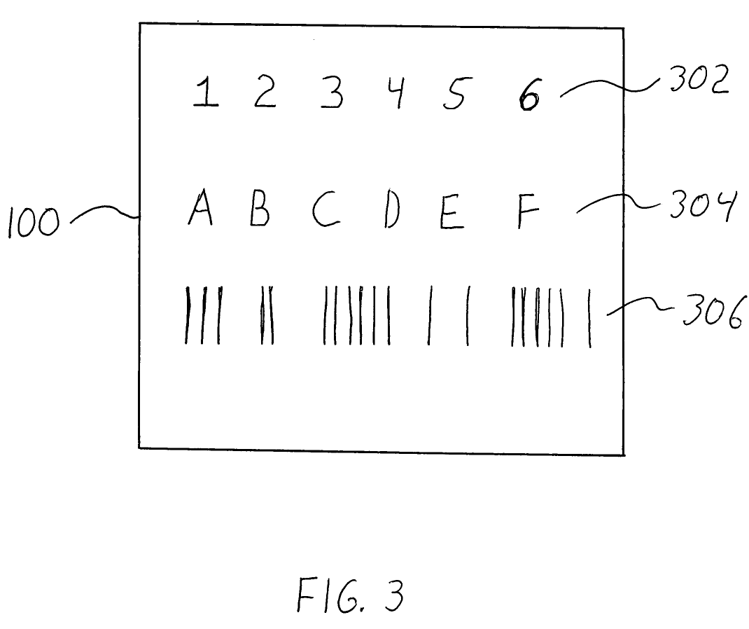

FIG. 3 shows several possible formats of the unique identifier 106, but is not meant to be an exhaustive list. The multiple formats of the unique identifier 106 are shown on the same tag 100 for illustrative purposes only. In practice, only one format of the unique identifier 106 need appear on a single tag 100, however multiple formats will not adversely affect the present invention.

The first format 302 of the unique identifier 106 is a standard Arabic number format. Number format 302 is advantageous because it is easily interpreted by a consumer, and can be easily entered via, computer keyboard, into a consumer's home computer 202 and then communicated over the internet 200 to the destination database 208 for verification of authenticity. The internet is well known by those having skill in the art, and thus a detailed description is not included in this discussion.

In format 304, shown in FIG. 3, letters are used to identify the item 102. In the example, the letters are sequential, but can spell a unique word or simply be random letters. In addition, the letters can be letters of various languages to facilitate use in foreign countries.

In format 306, shown in FIG. 3, the unique identifier is encoded into a barcode format. Barcodes are very well known by those in the art and provide a method of optically reading a code at a point of sale (POS) location. The bars are placed on the tag 100 at varying distances. An optical reader (not shown) scans the code 106, 306 by directing a light source to the tag 100. If the light contacts a white section, it is reflected back; if the light hits a dark line, less light is reflected back. In this manner, the scanner is able to interpret the number and distance between the bars to determine the code. Bar codes are advantageous because they are fast and reliable.

Additionally, it may be desirable for a retailer to prevent individuals from learning the content of the tag until a purchase is made. This encourages sales and prevents unauthorized registration/verification of identifiers 106 by non-purchasers. Bar codes are well suited for this situation, as the bar spacing is virtually impossible to interpret with the human eye. In addition, several other embodiments are effective for concealing the identifier 106.

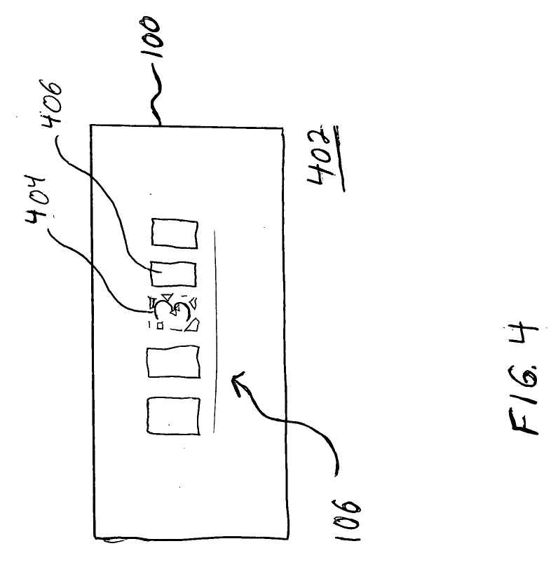

FIG. 4 shows an embodiment 402 of providing an identifier 106 on a tag 100, where the identifier is concealed from view. Format 402 in FIG. 4 shows Arabic numbers 404 covered with a removable coating 406. Coating 406 is similar to that used by most state lottery games and can be scratched off to reveal the characters underneath the material 406. Once removed, the material cannot be replaced. In the embodiment shown in the figure, the coating 406 has been partially removed from the middle character to partially reveal a number 404.

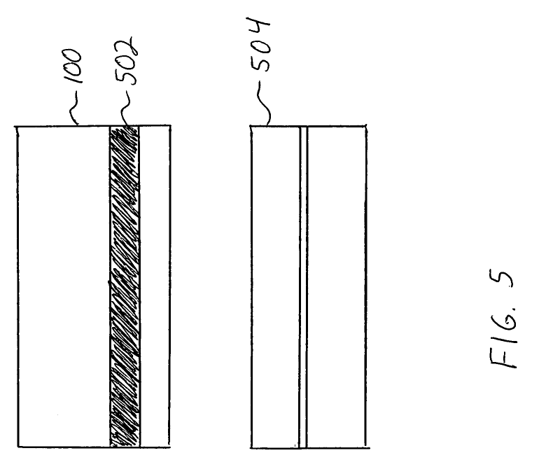

In still another embodiment, shown in FIG. 5, the tag 100 may be provided with a magnetic stripe 502, similar to a commonly known credit card. In this way, the consumer cannot learn of the information contained within the stripe 502 without the aid of a magnetic stripe reader 504. Stripe readers 504 at the retail counter can be used to interpret the identifier 106 contained within the magnetic stripe 502 and access the database 208 to verify the authenticity of the item 102. The stripe reader 504 can also be configured to create a format for the identifier 106, i.e., letters, number, etc., or password at the point of sale. This provides an added measure of security to the registration/authentication process.

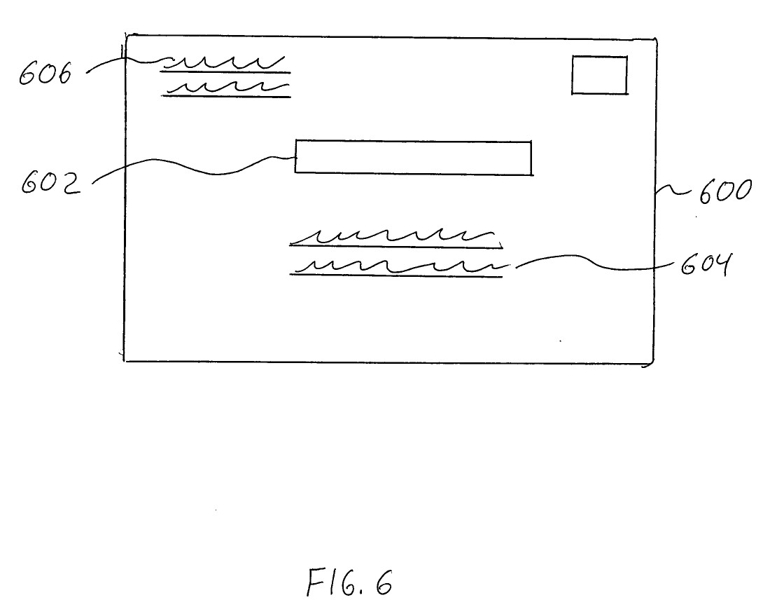

In yet another embodiment, a mail-in post card 600, shown in FIG. 6, can accompany a purchased item 102. The post card 600 includes a unique identifier 602, the address of the verification source 604, and field 606 to hold the address that the confirmation is to be delivered. Thus, the post card 600 can be mailed, by the purchaser, to a verification source, such as the manufacturer, for verification. Receipt of verification of the item will confirm that the item is as advertised.

With the system just described, a purchaser can quickly and easily confirm the source, production number, and pertinent information relating to an item purchased. Furthermore, access to the information can be restricted to a particular group of individuals.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

1. A clothing registration system comprising:
a unique identifier assigned a clothing item and identifying the clothing item's membership and position within a finite production run;
a database;
wherein a computer network is operable to receive a unique identifier confirmation request, search the database for a record corresponding to the unique identifier, and output a confirmation if the record corresponding to the unique identifier is located within the database.

2. The clothing registration system according to claim 1, wherein the database is accessible, via the internet, to a purchaser of the clothing item.

3. The clothing registration system according to claim 1, wherein the unique identifier comprises:
one of numbers, letters, characters, graphics, colors, shapes, scannable bars, magnetic stripes, and a combination thereof.

4. The clothing registration system according to claim 1, wherein the unique identifier comprises:
any means for distinguishing a first clothing item from a second clothing item.

5. The clothing registration system according to claim 1, wherein the unique identifier is attached to the clothing item.

6. The clothing registration system according to claim 1, wherein the computer network is one of an internet, a local area network (LAN), a wide area network (WLAN), and a telephone network.

7. The clothing registration system according to claim 1, wherein the record corresponding to the unique identifier is deleted after the confirmation is output by the computer network.

8. The clothing registration system according to claim 1, wherein the record corresponding to the unique identifier is altered to indicate that the unique identifier has been confirmed after the confirmation is output by the computer network.

9. The clothing registration system according to claim 1, wherein the record corresponding to the unique identifier includes the unique identifier.

10. The clothing registration system according to claim 1, further comprising the computer network being accessible to the general public.

11. The clothing registration clothing registration system according to claim 1, further comprising a code for accessing a private section of the computer network.

12. The clothing registration code according to claim 11, wherein the code is provided to a purchaser only after a sales transaction of the clothing item is complete.

13. The clothing registration system according to claim 1, wherein the unique identifier is not readable by a person until after a sales transaction of the clothing item is complete.

14. A method of substantiating a clothing item's membership within a finite group, the method comprising:
providing a unique identifier assigned a clothing item and identifying the clothing item's membership and position within a finite production run;
receiving a unique identifier confirmation request;
searching a database having at least one record corresponding to the unique identifier assigned to the clothing item for a record corresponding to the unique identifier; and
upon locating the record corresponding to the unique identifier, sending a confirmation that the record corresponding to the unique identifier is present within the database.

15. The method according to claim 14, wherein the unique identifier comprises:
one of numbers, letters, characters, graphics, colors, shapes, scannable bars, magnetic stripes, and a combination thereof.

16. The method according to claim 14, wherein the unique identifier comprises:
any means for distinguishing a first clothing item from a second clothing item.

17. The method according to claim 14, further comprising:
attaching the unique identifier to the clothing item.

18. The method according to claim 14, wherein the computer network is one of an internet, a local area network (LAN), a wide area network (WLAN), and a telephone network.

19. The method according to claim 14, further comprising:
deleting the record corresponding to the unique identifier after the confirmation is sent.

20. The method according to claim 14, further comprising:
altering the record corresponding to the unique identifier to indicate that the unique identifier has been confirmed after the confirmation is sent.

21. The method according to claim 14, wherein the record corresponding to the unique identifier includes the unique identifier.

22. The method according to claim 14, further comprising:
providing public access to the computer network.

23. The method according to claim 14, further comprising:
providing a code to the purchaser for accessing a private section of the computer network.

24. The method according to claim 23, further comprising providing a code to the purchaser only after a sales transaction of the clothing item is complete.
